(19) United States
(12) Patent Application Publication
(10) Pub. No.: US 2004/0051361 A1
(43) Pub. Date: Mar. 18, 2004

(54) Motor vehicle seat

(76) Inventors: Peter Rausch, Coburg (DE); Wolfgang Suck, Coburg (DE); Christina Schewerdtner, Neustadt (DE)

Correspondence Address: CHRISTIE, PARKER & HALE, LLP, 350 WEST COLORADO BOULEVARD, SUITE 500, PASADENA, CA, 91105, US

(21) Appl. No.: 10/416,759

(22) PCT Filed: Nov. 13, 2001
(86) PCT No.: PCT/DE01/04274

(30) Foreign Application Priority Data
Nov. 15, 2000 (DE) 100 57 724.5

(51) Int. Cl. B60N 2/20

(52) U.S. Cl. 297/341

(57) ABSTRACT

The invention relates to a motor vehicle seat comprising: a seat frame, a seat back, which is pivotally mounted on the seat frame, and which can be tilted forward toward a sitting surface of the seat frame; a longitudinal guide, with which the seat frame can be displaced in the longitudinal direction of the seat in order to adjust the longitudinal position of the seat; a detent device for locking the seat frame in a pre-adjusted longitudinal position of the seat; an actuating element for unlocking the detent device so that the seat frame can be displaced in the longitudinal direction of the seat; and, a coupling mechanism, which acts upon the actuating element and unlocks the detent device when the seat back is tilted forward the seating surface. According to the invention, an actuation stop is provided on a part that can swivel together with the seat back, and when the seat back is tilted forward toward the sitting surface, the actuation stop acts upon a coupling element, which is rotatably mounted on the swivel axis and which forms a component part of the coupling mechanism.

### DESCRIPTION

The invention relates to a motor vehicle seat according to the preamble of patent claim 1. This comprises for example a seat frame, a seat surface provided on the seat frame and a backrest which is mounted pivotally on the seat frame and can be tipped forwards towards the seat surface.

Seats of this kind are used as front seats in motor vehicles whereby folding the backrest forwards makes it easier for a passenger to climb in or place articles in the back of the vehicle. An additional ease of entry, which is particularly important in the case of two-door vehicles, is achieved if after tipping the backrest forwards the seat itself can be pushed forwards. For this the vehicle seat has the following:

a longitudinal guide with which the seat frame can be moved in the longitudinal direction to adjust the longitudinal position of the seat;

a fixing device for locking the seat frame in a previously set seat longitudinal position;

an operating element for releasing the fixing device so that the seat frame can be moved in the seat longitudinal direction;

a coupling mechanism for coupling the fixing device to the backrest which acts on the operating element and thereby releases the fixing device when the backrest has been tipped forwards towards the seat surface;

a memory device by means of which the seat frame during movement in the seat longitudinal direction can be stopped automatically in a predetermined seat longitudinal position which has been defined as the memory position whereby a stop associated with the seat frame and movable in the seat longitudinal direction enters into engagement with a counter stop of the memory device;

adjusting means for the memory device with which the memory position can be adjusted by sliding the position of the counter stop in the seat longitudinal direction;

a locking device for the memory device for locking a set memory position and

switching means with which the locking device can be released in order to be able to set the memory position.

A seat of this kind known from WO 00/55002 offers on the one hand the possibility, after tipping the backrest forwards towards the seat surface, of moving the seat frame and thus the entire vehicle seat forwards in order to facilitate entry of the passenger into the rear of the vehicle (easy-entry function). At the same time the seat can then be moved very simply again into its original seat longitudinal position when this seat longitudinal position is stored as the memory position by means of the memory device provided for this purpose. In this case the seat frame is stopped automatically in the memory position when the seat is pushed back whereby a stop associated with the seat frame interacts with a counter stop of the memory device.

The object of the invention is to provide a motor vehicle seat of the type already mentioned which is characterised by a simple and reliable coupling of the coupling mechanism with the pivotal backrest.

This is achieved according to the invention by providing a motor vehicle seat with the features of patent claim 1.

According to this an operating stop is provided on a component part which is capable of pivoting together with the backrest so that as the backrest is tipped forwards onto the seat surface the operating stop acts on a rotatably mounted coupling element which forms a constituent part of the coupling mechanism and hereby actuates the coupling mechanism so that this acts on the operating element of the fixing device.

The coupling element is preferably mounted in the region of the pivotal axis of the backrest and more particularly on this pivotal axis itself. This has the advantage that the coupling mechanism provided for operating the fixing device can be readily mounted at its end remote from the fixing device in the region of the or on the pivotal axis of the backrest. The seat underframe (without backrest or with only one part of the backrest, namely a backrest fitment) can hereby be made and supplied together with the release mechanism for the fixing device to fulfil the easy-entry function as one completely preassembled structural unit on which the backrest can then be fixed.

In a preferred embodiment the component part which is able to pivot together with the backrest is formed as a backrest fitment.

The operating stop can be formed for example by a section of the outer contour of the component part which can swivel together with the backrest or also through a projection protruding therefrom.

According to one variation of the invention the coupling mechanism which couples the backrest to the fixing device comprises a lever mechanism which extends from the component part which can pivot together with the backrest to the fixing device. In order in the case of a vertically adjustable seat to be able to compensate a change in the height of the pivotal axis of the backrest relative to the seat longitudinal guide, this lever mechanism can have a corresponding articulated joint or longitudinal guide. The component part which can pivot together with the backrest can hereby form a part of the lever mechanism.

According to another variation of the invention the coupling mechanism comprises a Bowden cable which extends from the component part which can pivot together with the backrest, to the fixing device whereby the core of the Bowden cable is fixed directly or indirectly (through further elements) to the said component part.

The use of a lever assembly as an essential constituent part of the coupling mechanism as the advantage that the risk of the cable tearing, which exists in the case of a Bowden able, is avoided.

According to a further development of the motor vehicle seat according to the invention a memory device is provided by means of which the seat frame during movement in the seat longitudinal direction can be stopped automatically in a predetermined seat longitudinal position defined as a memory position whereby a stop associated with the seat frame and movable in the seat longitudinal direction enters into engagement with a counter stop of the memory device.

Furthermore adjusting means are provided for the memory device through which the memory position can be adjusted in the seat longitudinal direction whereby a locking device for the memory device serves to lock the set memory position and furthermore switch means are provided for releasing the locking device.

Furthermore it can be proposed that the coupling mechanism which acts on the operating element of the fixing device and releases this when the backrest has been tipped forwards onto the seat surface acts on the operating element only so long as the backrest is tipped forwards. Thus the seat frame can be locked at any time by locking the fixing device when the backrest is no longer tipped forwards, thus has been returned to its function position. This means in particular that with the backrest raised up the seat frame can be locked in a current seat longitudinal position irrespective of whether the relevant seat longitudinal position corresponds to the memory position.

This leads on the one hand to an increase in the operating comfort since there is a greater variability regarding the seat longitudinal positions which can be adjusted and locked according to the design of the easy entry function. At the same time the functional reliability is improved as the seat can also be locked when it is not located in the memory position so that no security risk can arise as a result of an inadequately secured seat.

By seat frame is meant thereby in the present case all constituent parts of the supporting seat structure which can be moved in the seat longitudinal direction, thus in particular those constituent parts of the seat longitudinal guide such as e.g. a seat rail (top rail) which are moved when adjusting the seat longitudinal position in the longitudinal direction.

In a preferred embodiment of the invention blocking means are provided which are coupled to the backrest and which when the backrest is tipped forwards act on the switch means provided for releasing the locking device of the memory device so that with the backrest tipped forwards release of the locking device is prevented. This means that with the backrest tipped forwards the locking device for the memory device is always locked so that no change can be made to the memory position.

The blocking means can be coupled to the backrest for example through push means or traction means, more particularly in the form of a cable. A lever assembly or other gearing can however also be used for coupling. It is only necessary that the means used for coupling are suitable to convert a swivel movement of the backrest into a movement of the blocking element and to bring this into a position in which it blocks unlocking of the locking device of the memory device.

The blocking means can thereby be coupled to the backrest through the same coupling mechanism as the operating element which with the backrest folded forwards causes unlocking of the fixing device for the seat longitudinal guide.

In order to bring a blocking element of the locking means into engagement with the switch means it can be proposed for example to move the blocking element in the longitudinal direction of the seat when folding the backrest forwards. Alternatively a swivel movement of the blocking element when folding the backrest forwards or even another type of movement can also be provided.

The blocking element has for example a stop which on folding the backrest forwards enters into engagement with the switch means in order to block release of the locking device of the memory device. Alternatively the blocking element can also be connected to the switch means and as the backrest is folded forwards acts on the switch means so that release of the locking device is hereby prevented.

The switch means provided for releasing the locking device of the memory device can be formed for example by a switch lever or by a switch spring whereby the former is swivelled to release the locking device and the latter is deformed. Likewise a displaceable switch means can be used.

The switch means are preferably mounted on the seat frame and are arranged so that they can only then act to release the locking device when the seat frame is in the memory position. This means that a change in the memory position which does indeed provide for release of the locking device can only then be undertaken when the seat frame is located in the actual memory position.

In an advantageous further development the switch means are elastically pretensioned towards a first switch position and can be shifted into a second switch position against this pretension action whereby in one of the two switch positions the locking device is locked and in the other switch position the locking device is released.

In another embodiment of the invention the switch means are coupled to the fixing device of the seat longitudinal direction when the seat frame is located in the memory position and can therefore be switched simultaneously when operating the fixing device.

According to one variation the switch means are hereby switched on releasing the fixing device so that the locking device is released. This means that when releasing the fixing device of the seat longitudinal guide in the memory position the locking device of the memory device is also released at the same time so that a new memory position can be set. However through the aforementioned blocking means it can hereby be ensured that this is only then possible when the backrest is not in the forward-folded position. For during displacement of the seat for the purpose of easier entry into the vehicle as a rule no changes can be made to the memory position.

According to another variation the switch means when locking the fixing device of the seat longitudinal guide are switched so that the locking device for the memory device is released. With this variation the adjusting means for the memory device provided to change the memory position are thus automatically disconnected when locking the fixing device of the seat longitudinal guide. If then the fixing device is again released so that the seat frame can be displaced in the seat longitudinal direction then at the same time a correction of the memory position can take place. Obviously also here by means of the aforementioned blocking means it can be effected that the disconnection of the adjusting means of the memory device is only possible when the backrest is not tipped forwards.

Furthermore it can be proposed that in the memory position of the seat frame when the backrest is not tipped forwards and when the locking device for the memory device is released the switch means are supported so that during release of the fixing device the switch means are not shifted. To this end the switch means can be supported for example on a support surface or can also be pretensioned into a certain position by means of an elastic element.

In order to prevent the adjusting means of the memory device from being disconnected automatically when approaching the memory position with the result that during subsequent adjustment of the seat longitudinal position the memory position would also be changed at the same time, it can be proposed that the switch means on approaching the memory position with the backrest not tipped forwards are first deactivated and an immediate release of the locking device of the memory device is thereby blocked. During subsequent locking of the fixing device the switch means can then be operated again so that they can again act on the locking device of the memory device to release same. This can be achieved in particular in that the locking device is automatically released during any subsequent release of the fixing device.

In order to deactivate the switch means on approaching the memory position with the backrest not tipped forwards it can be proposed that a guide face of the memory device is assigned to the switch means and that this guide face is designed so that the switch means on approaching the memory position are guided along the guide face and can thereby not act on the locking device. During subsequent locking of the fixing device the switch means can then automatically be operated so that they are again lifted from the guide face. During subsequent renewed release of the fixing device (with the backrest not tipped forwards) the switch means can then act again on the locking device of the memory device in order to disconnect the adjusting means.

In another embodiment the switch means are assigned a stop face of the memory device which is arranged so that on approaching the memory position with the backrest not tipped forwards it acts on the switch means in order to prevent release of the locking device through the switch means. During subsequent locking of the fixing device the switch means are thereby actuated so that they are lifted again from the stop face.

In a preferred further development of the invention the locking device of the memory device is elastically pretensioned towards its locked position and the switch means can in the memory position with the backrest not tipped forwards act on the locking device so that the latter is released against the elastic pretension.

The locking device of the memory device preferably consists of a locking unit which can be pushed together with the counter stop of the memory device in the seat longitudinal direction, and of a catch device associated with the locking unit and having detent settings arranged in succession in the seat longitudinal direction at which the locking unit can be locked relative to the catch device to fix the memory position.

The locking unit can comprise for example a swivel mounted locking pawl which has a catch element which can engage in the detent settings of the catch device whereby the locking pawl is provided with an operating section on which the switch means can act in order to enable the catch element to engage in the catch device or disengage therefrom.

In order when setting the seat longitudinal position also to be able to adapt the memory position the memory device has a follower which can be brought into engagement with the seat frame so that the counter stop and locking unit of the memory device can be moved together with the seat frame in the seat longitudinal direction. For this an engagement area of the seat frame is dedicated to the follower and the follower can be brought into engagement with this engagement area eg by pivoting the follower and engagement area relative to each other.

The follower and engagement area are preferably only then able to engage with each other when the seat frame is located in the memory position and when the locking device of the memory device is released. The follower itself can be mounted for example on the locking pawl.

The adjusting means with which the memory position can be adjusted can advantageously be formed by a slider which is mounted movable in the seat longitudinal direction and on which the locking unit and counter stop of the memory device are mounted.

Further features and advantages of the invention will now be described in further detail with reference to the embodiment shown in the drawings in which:

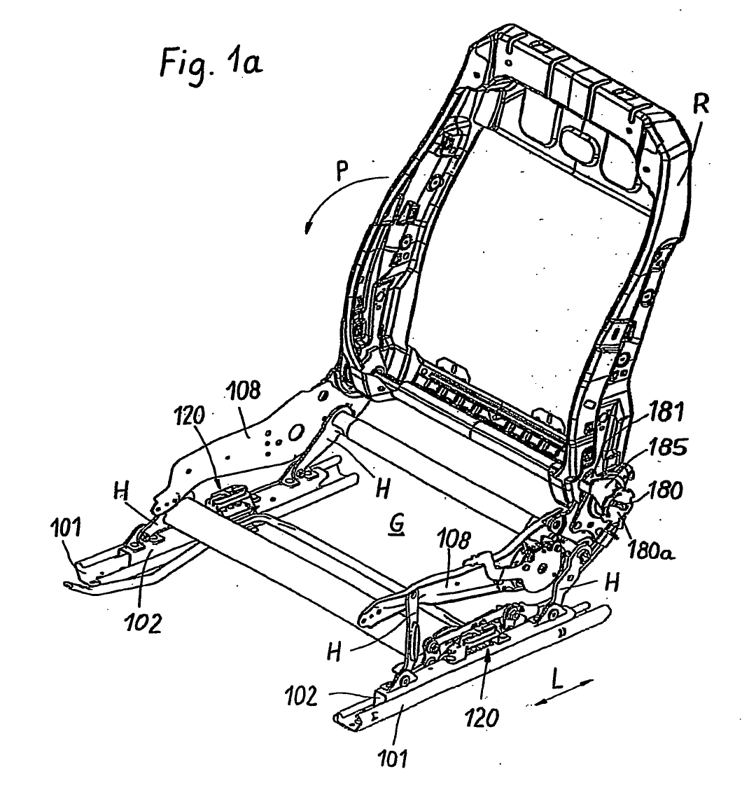

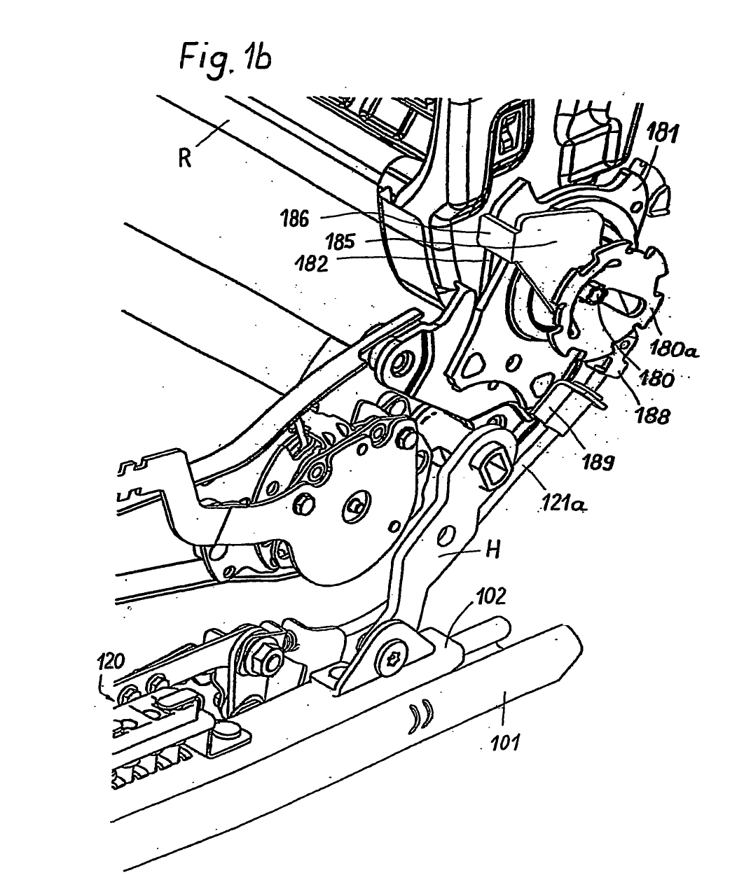

FIG. 1a shows a perspective view of a seat frame having a backrest, seat longitudinal guide, fixing device for the seat longitudinal guide and a coupling mechanism which releases the fixing device as the backrest is tipped forwards onto the seat surface;

FIG. 1b shows a detail from FIG. 1a in the area of the pivotal axis of the backrest;

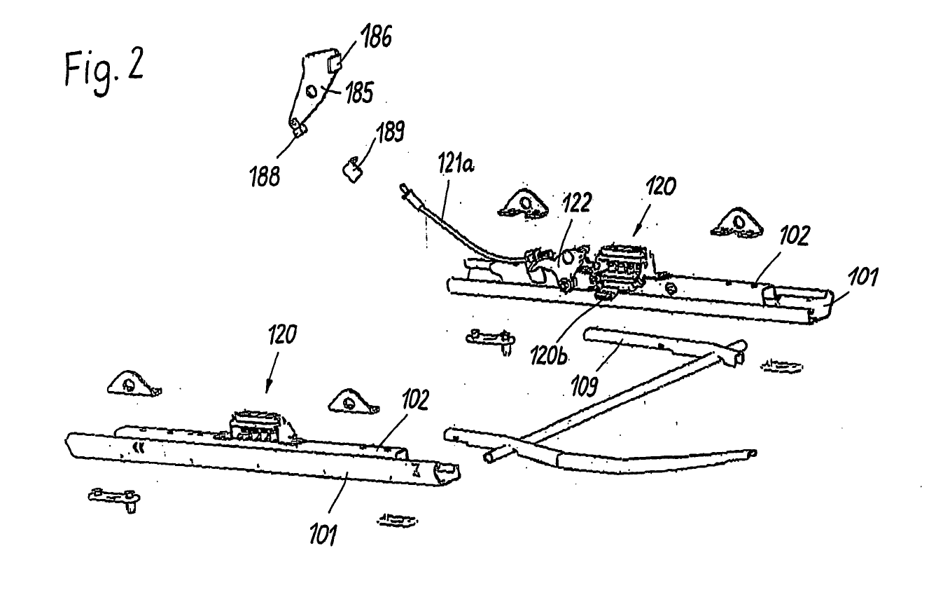

FIG. 2 shows an exploded view of part of the seat frame of FIG. 1a;

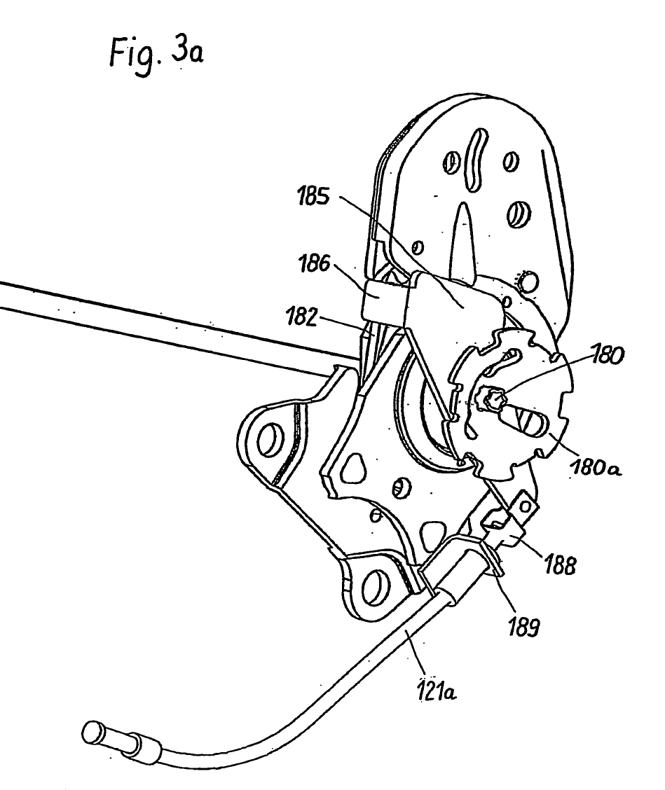

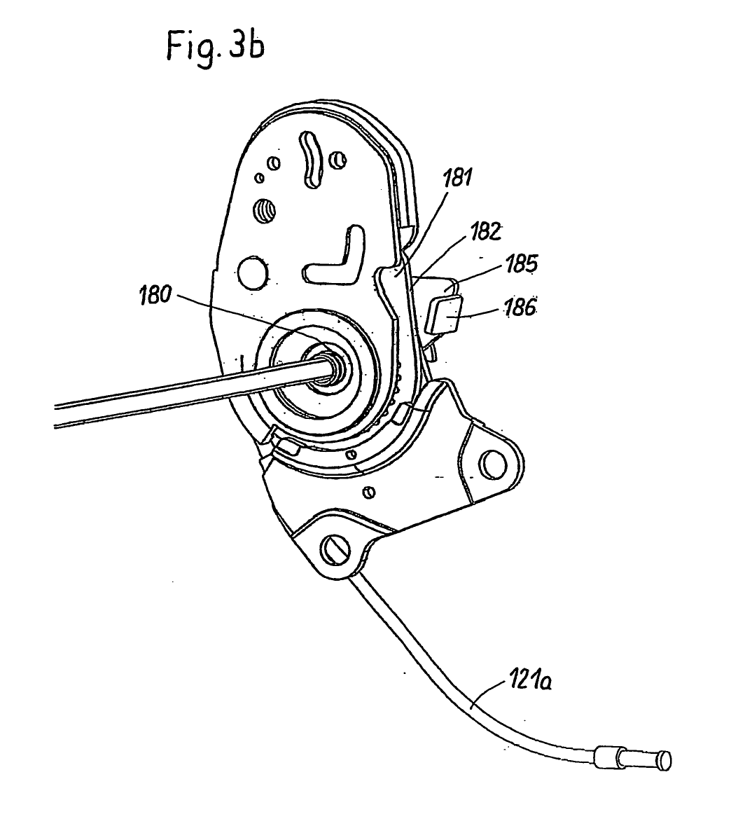

FIG. 3a shows a further perspective view of part of a seat frame in the region of the pivotal axis of the backrest in a position in which the backrest is tipped forwards onto the seat surface;

FIG. 3b shows a view according to FIG. 3a in a position in which the backrest is located in a useful position;

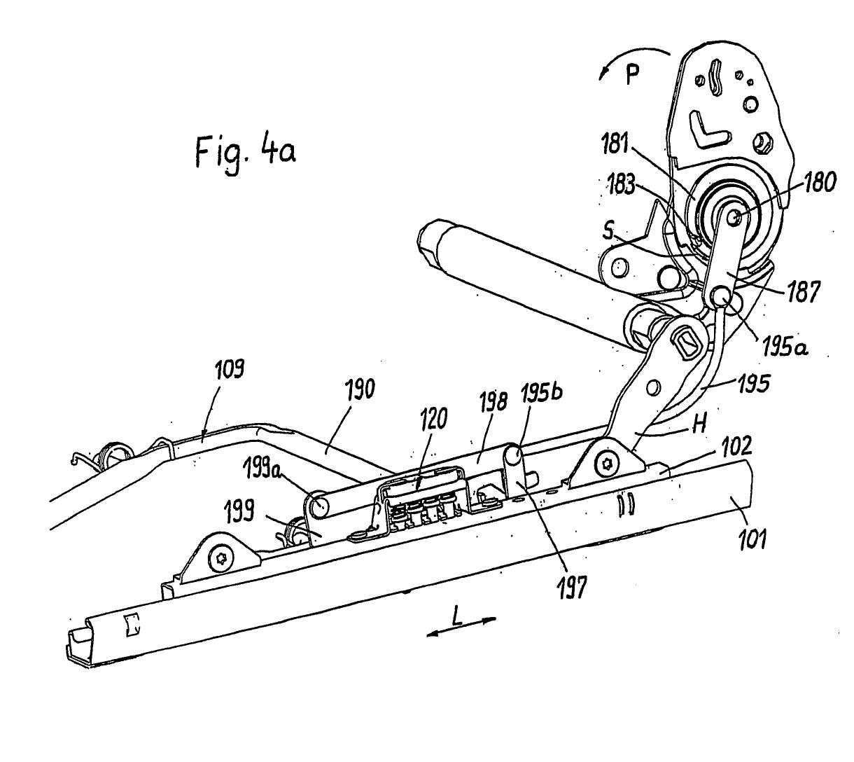

FIG. 4a shows a perspective view of a first modification of the embodiment of FIGS. 1a to 3b;

FIG. 4b shows a second perspective view according to FIG. 4a;

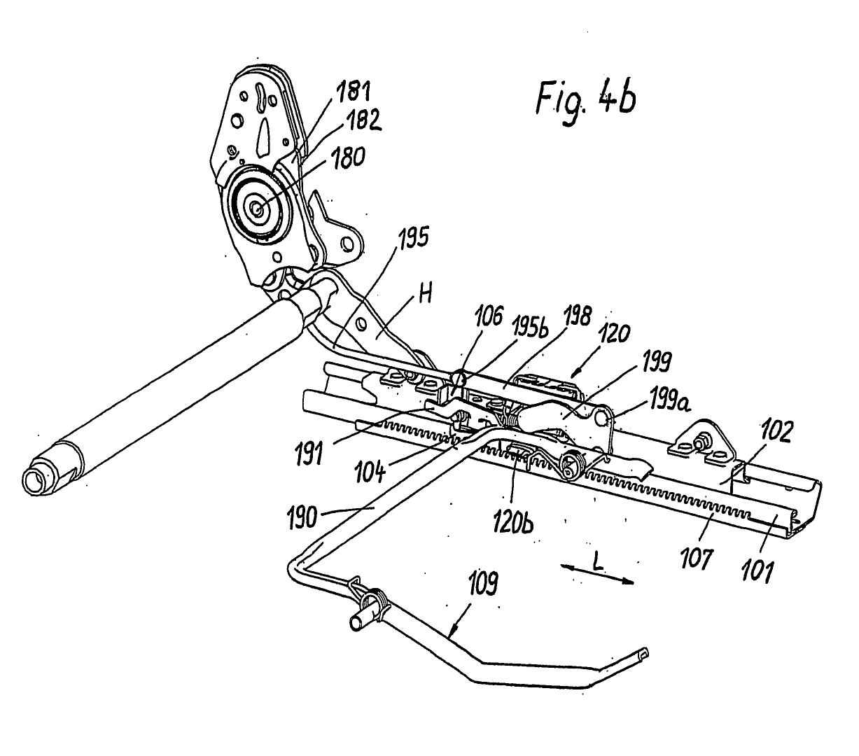

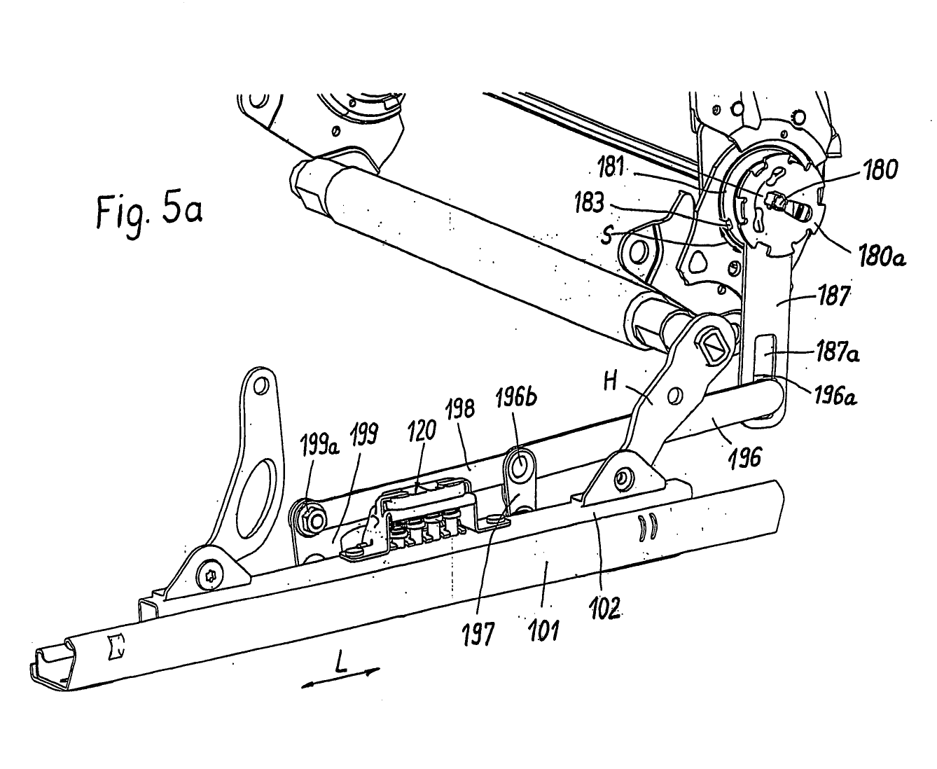

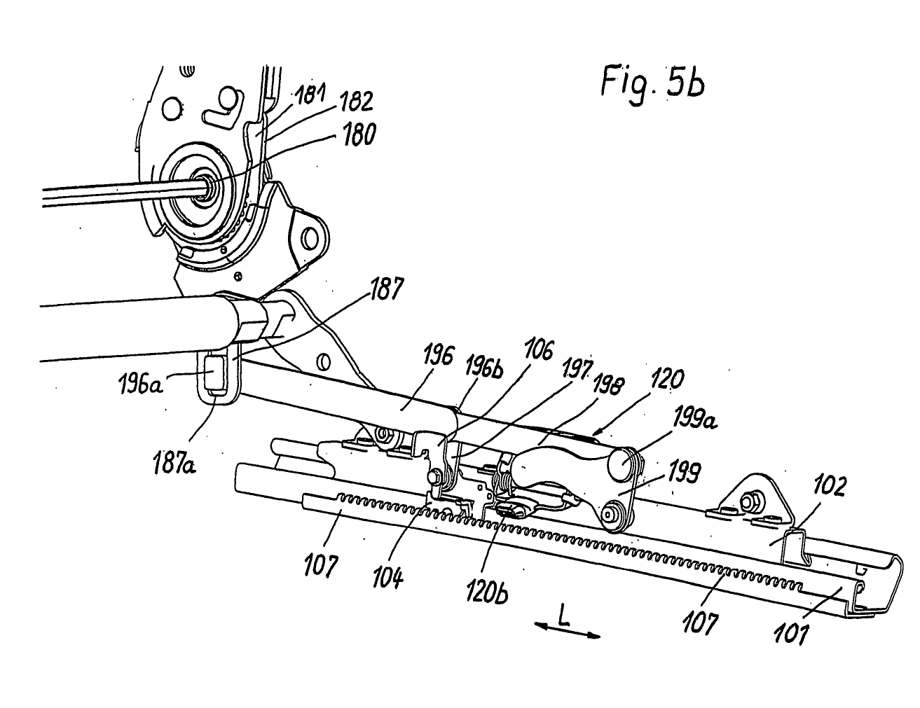

FIG. 5a shows a perspective view of a second modification of the embodiment of FIGS. 1a to 3b;

FIG. 5b shows a second perspective view according to FIG. 4a;

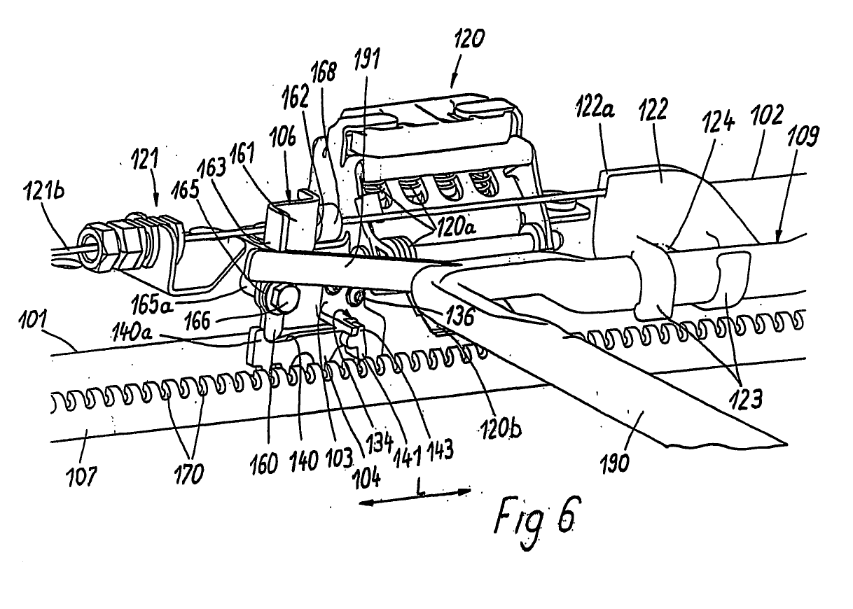

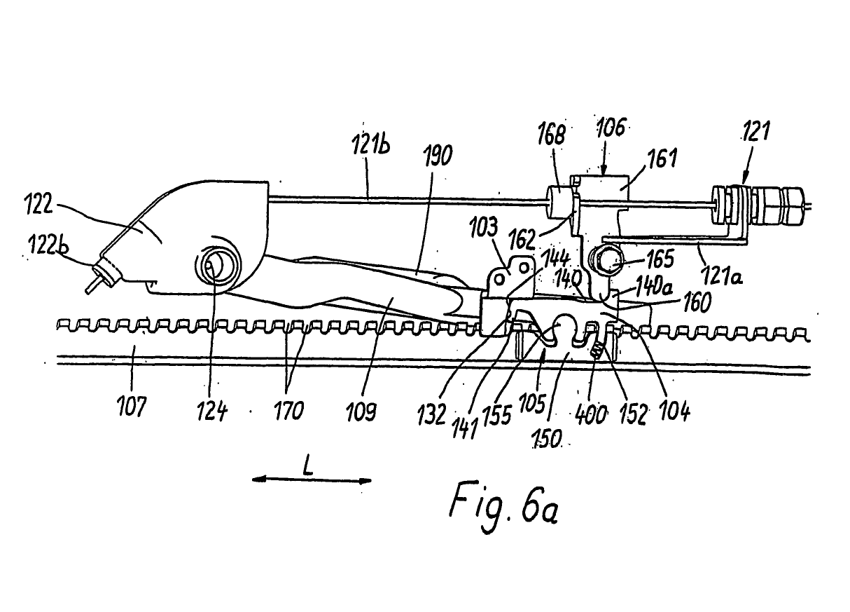

FIG. 6 shows a perspective view of part of a seat frame known from the prior art with a seat longitudinal guide, a fixing device of the seat longitudinal guide, a seat side part on which the backrest is swivel mounted as well as with a programmable memory device for automatically seeking a predetermined seat longitudinal position;

FIG. 6a shows a rear view of the illustration in FIG. 6;

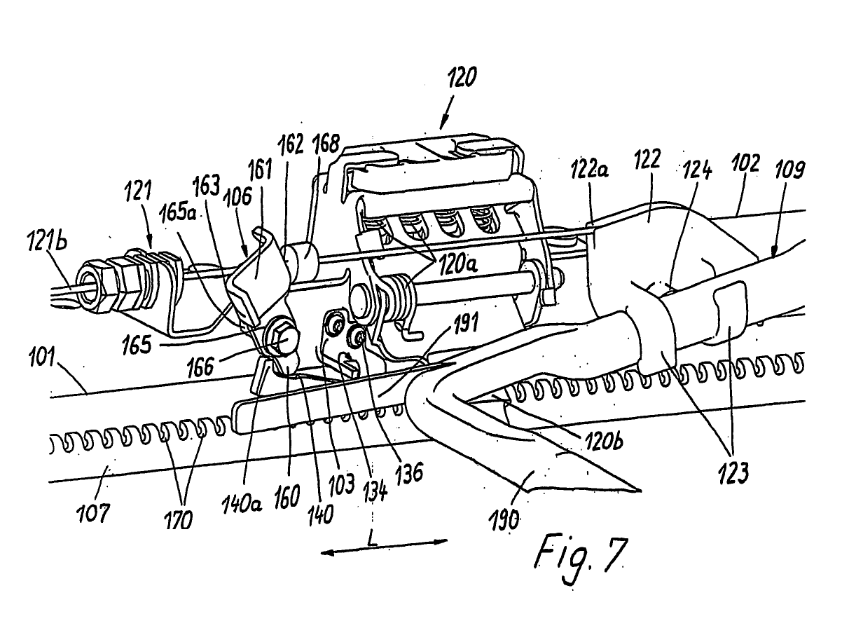

FIG. 7 shows a view according to FIG. 6 in a state in which the backrest is tipped forwards in order to be able to slide the seat with the backrest tipped forwards;

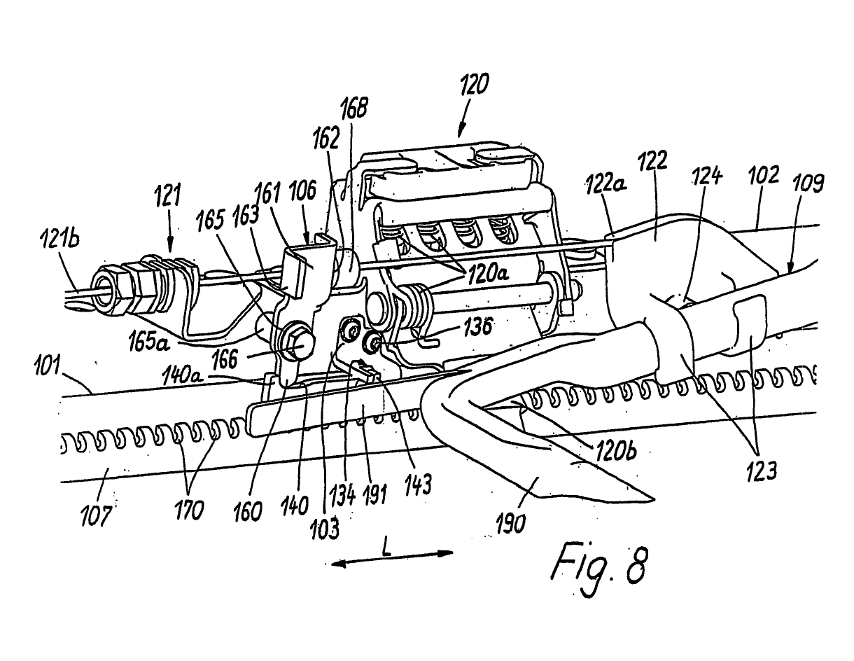

FIG. 8 shows a view according to FIG. 6 in a position in which with the backrest raised up in the memory position an operating lever was actuated in order to re-set a new memory position;

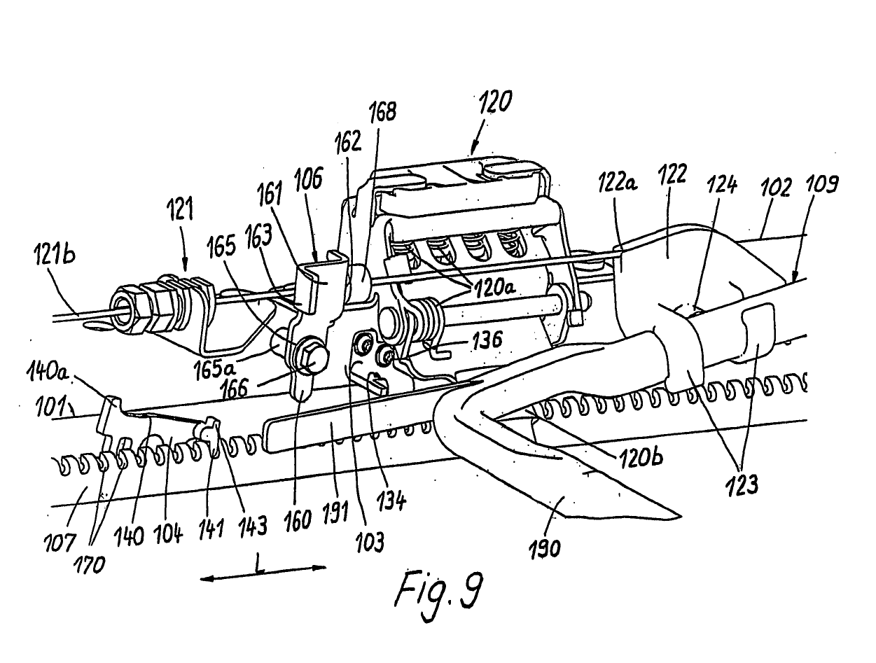

FIG. 9 shows a view according to FIG. 6 in a position in which the memory position of the seat is approached with the backrest raised up;

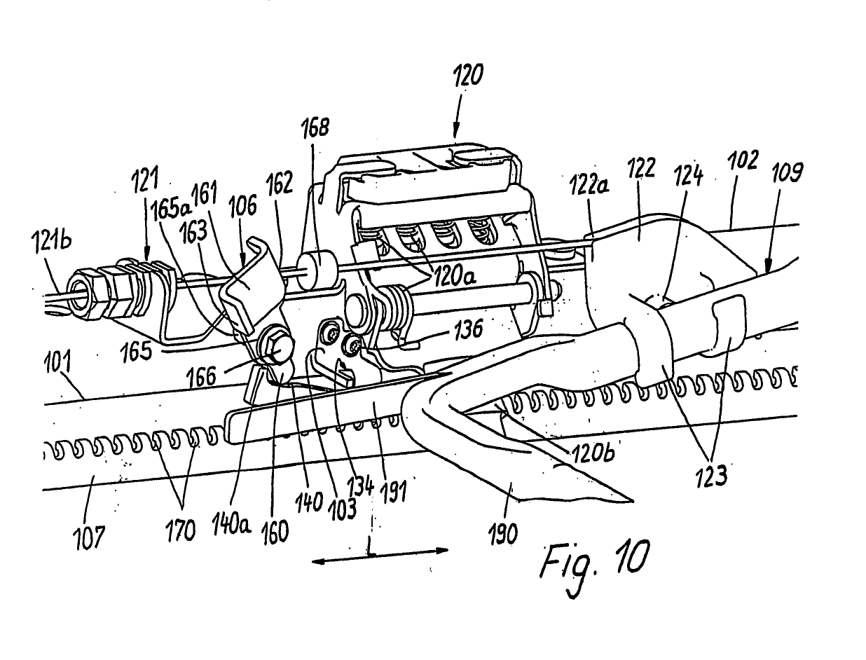

FIG. 10 shows a view according to FIG. 6 in a position in which the memory position of the seat is reached with the backrest raised up;

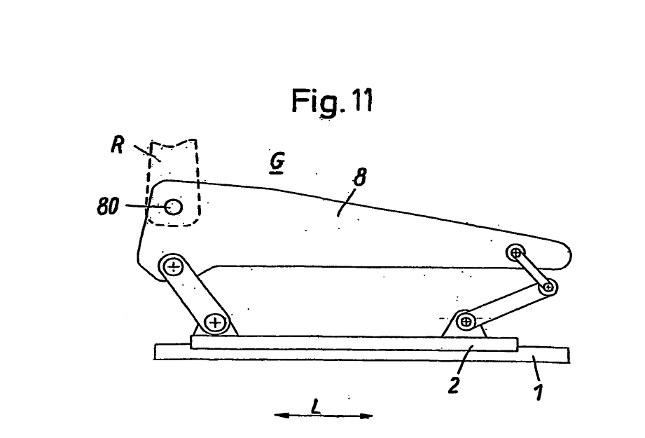

FIG. 11 shows a diagrammatic view of a seat frame.

The seat frame G (seat underframe) shown in side view in FIG. 11 comprises a seat rail 2 which is mounted movable in the seat longitudinal direction L on a lower rail 1 to be fixed on the vehicle body, and a seat side part 8 which is attached vertically adjustable on the seat rail 2 through front and rear articulated levers. On the other longitudinal side (not shown in FIG. 11) the seat frame G has a corresponding assembly 7. Between the seat side parts of the seat frame G extends a seat surface which holds a seat cushion on which a vehicle occupant can be seated.

Furthermore the side parts 8 of the seat frame G each have a bearing point 80 for pivotally mounting a backrest R which is shown in dotted lines in FIG. 11.

Here, parts of the seat frame are to mean all those component parts which are movable in the seat longitudinal direction on the lower frame 1 fixed on the body, thus in particular the seat rail 2, seat side part 8 as well as the further component parts of the seat connected therewith.

If a vehicle seat of this kind which is adjustable in the longitudinal direction L is used for a two door vehicle it is known in order to facilitate entry in the rear of the vehicle to couple the backrest to the seat longitudinal adjustment namely so that when the backrest R is folded or tipped forwards towards the seat surface which extends between the seat side parts 8 a fixing device which is dedicated to the seat longitudinal guide 1, 2 is released and the seat can be pushed forwards with the backrest tipped forward. This is the so-called easy-entry function.

In the following the basic principle of the easy-entry function when using a programmable memory device for automatically seeking a predeterminable seat longitudinal position will be explained first in respect of a seat assembly illustrated in FIGS. 6 and 10 and known from WO 00/55002. For further details on this reference is made to WO 00/55002 which relates expressly to the subject of the present specification.

The perspective front view of FIG. 6 and the associated rear view according to FIG. 6a show a rail 101 fixed on the body and a seat rail 102 movably guided thereon in the seat longitudinal direction L whereby a ratchet rail 107 having a number of detent openings 170 arranged in succession thereon in the seat longitudinal direction L is fixed on the rail 101 which is fixed on the body. The seat rail 102 supports the remaining components of the seat frame, see FIG. 11.

The seat rail 102 can be locked relative to the rail 101 fixed on the body by means of a fixing device 120. This can be a conventional fixing device for a seat longitudinal adjustment. FIGS. 6 and 6a show the housing, a swivel mounted operating element 120b as well as a torsion spring of a known fixing device (whose housing is fixed on the seat rail 2) acting on the operating element 120b. The torsion spring serves inter alia to remove the play from the assembly in order to prevent rattling noises.

This fixing device comprises for example according to DE 299 10 720 U1 a number of locking teeth arranged inside the housing and pretensioned by means of springs mounted in the form of coil springs in the housing—elastically in the direction of a catch device fixed on the body-side rail 1 and not visible in FIGS. 6 and 6a. As a result of the pretension acting on the locking teeth the locking teeth dedicated to the seat rail 102 automatically engage in the catch device fixed on the body so that the seat longitudinal adjustment is locked unless the locking teeth are disengaged from the catch device by means of the operating elements 120b provided for this purpose.

Since the operating element 120b of the fixing device 120 is pretensioned by means of the spring assembly 120a which consists of the springs acting on the locking teeth and mounted inside the housing, as well as of the torsion spring mounted outside of the housing, against the direction in which it has to be swivelled in order to release the fixing device 120, the fixing device 120 can only then be released if a force is exerted on the operating element 120b against the action of the spring assembly 120a.

In order to release the fixing device 120 the operating element 120b can be operated on the one hand directly by a seat user who seizes an operating lever 109 swivel mounted on the seat frame and having a cross bar 190, by its operating handle 190 provided for this purpose (and not visible in FIGS. 6 and 6a), and swivels it anti-clockwise whereby the operating element 120b is moved against the pretension of the spring assembly 120a. On the other hand the fixing device 120 can also be released by tipping the seat back forwards whereby the seat back is coupled to the operating lever 109 through a Bowden cable which has a cable 121b and whose Bowden (not shown) is supported on a Bowden support 121. Furthermore a gearing part 122 which has a guide 122a as well as a mounting 122b for the cable 121b of the Bowden cable is mounted on the pivotal axis of the operating lever 109 by means of an axle shaft 124. The gearing part 122 converts tightening of the cable 121b as the backrest is tipped forwards into a pivotal movement which in turn is transferred through two arms 123 of the gearing which engage round the operating lever 109, to the operating lever itself. The operating lever 109 is hereby swivelled clockwise as the backrest is folded forwards to release the fixing device 120 through the operating element 120b.

A cable nipple 168 is fixed, e.g. squashed on the cable 121b of the Bowden cable between the Bowden support 121 which is fixed on the seat rail by means of a fixing plate 121a and the gearing 122. The cable nipple 168 is assigned a switch element in the form of a switch lever 106 which is mounted by means of a bearing bush 165, a stepped bolt 165a and a screw 166 to pivot about an axle formed by the longitudinal axle of the stepped bolt 165a and at the same time is fixed on the seat frame or its seat rail 102. The switch lever 106 has in the upper section 161 a stop 162 which is mounted directly adjacent the cable nipple 168 and on which the cable nipple 168 can act in the seat longitudinal direction whereby the switch lever 106 is swivelled.

The second end section of the switch lever 106 mounted beneath the bearing bush 165 and the stepped bolt 165a forms an operating section 160 which is assigned an operating section of a locking pawl 104 of the memory device. The operating section of the locking pawl 104 is thereby formed by an operating face 140 on the top side of the locking pawl.

The switch lever 106 is here locked by a projection 191 of the operating lever 109 on which the upper section 161 of the switch lever 106 is supported vertically by a stop 163 (across the seat longitudinal direction L) in the position shown in FIGS. 6 and 6a in which its operating section 160 acts on the operating face 140 of the locking pawl 104. The torque required for this is applied through the spring assembly 120a of the fixing device 120 which acts on the lever projection 191 through the operating element 120b and the operating lever 109.

As an alternative or in addition the perpendicular position of the switch lever 106 can be assisted through a spring mounted directly on the switch lever 106 or by mounting the switch lever 106 with sufficient friction which cannot be overcome through the action of the compression spring 400 of the locking pawl 104.

The locking pawl 104 itself is as can be seen in particular from FIG. 6a swivel mounted on the bearing pin 155 of a slider 105 which is guided with the base body 150 in the seat longitudinal direction movably next to the catch openings 170 of the ratchet rail 107. The slider has in its base body 150 a recess 152 in which a compression spring 400 is mounted which acts underneath the operating section 140 of the locking pawl 104 on same thereby pretensioning the locking pawl 104 so that a detent hook 141 at the other end of the locking pawl 104 has the tendency to engage in the ratchet rail 107. In the situation illustrated n FIGS. 6 and 6a in which the seat is locked in the memory position with the backrest not tipped forwards the locking pawl is hereby blocked in that the operating section 160 of the switch lever 106 is supported on the operating face 140 of the locking pawl 104 so that this cannot swivel about the bearing pin 155 in order to bring the detent hook 141 into engagement with the ratchet rail 107.

In the situation illustrated in FIGS. 6 and 6a a counter stop 144 of the locking pawl 104 is in contact with a stop 132 of a stop element 103 which is fixed by fixing screws 136 on the seat rail 102. Furthermore a follower 143 of the locking pawl 104 which adjoins the stop 144 at the top is in engagement with an engagement area 134 of the stop element 103.

If in the position of the seat shown in FIGS. 6 and 6a in which the seat is locked in the memory position the backrest is then tipped forwards the cable 121b of the Bowden cable is tensioned and is moved towards the rear seat end (on the side of the backrest).

According to FIG. 7 on the one hand the operating lever 109 is hereby swivelled anti-clockwise through the gearing part 122 and the arms 123 whereby it acts on the operating element 120b and releases the fixing device 120. On the other hand the cable nipple 168 which is squashed on the cable 121b is moved towards the rear seat end and thereby acts on the stop 162 in the upper section 161 of the switch lever 106. The switch lever 106 is thereby swivelled anti-clockwise whereby its operating section 160 is lifted from the associated operating surface 140 of the locking pawl 104. This swivel movement of the switch lever 106 is possible since this is no longer blocked through the lever projection 191 which would indeed be swivelled downwards together with the operating lever 109. Since the switch lever 106 has released the locking pawl 104 the latter now swivels through the action of the compression spring 400 (see FIG. 6a) about the bearing pivot 155 of the slider 105 until the detent hook 141 engages in an opening 170 of the ratchet rail 107. The locking pawl 104 and thus the memory device as a whole is hereby locked.

The pivotal movement of the locking pawl 140 has the result that the follower 143 of the locking pawl 104 as well as the engagement area 134 of the stop element 103 come out of engagement. This is necessary in order to be able to move the seat frame since otherwise movement of the seat would be blocked by the locked memory device.

The cable nipple 168 thereby serves as locking means which with the backrest tipped forwards acts on the switch lever 106 so that the locking pawl 104 cannot be released by means of the switch lever 106.

The assembly is designed so that when folding the backrest forwards the detent hook 141 can engage under the action of the compression spring 400 in the detent opening 170 before the fixing device 120 is released so that the seat rail 102 can be moved relative to the rail 101 fixed on the body. A reliable storing of the actual seat longitudinal position as memory position is hereby guaranteed. If the detent hook 141 cannot immediately engage in a catch opening 170 because the seat is positioned so that the detent hook 141 stops under the action of the compression spring 400 on a web between two catch openings 170 then the detent hook 141 only engages in the next catch opening 170 it passes after a slight displacement of the seat frame in the seat longitudinal direction L. In such a case there is a slight deviation between the seat longitudinal position when tipping the backrest forwards and the subsequently stored memory position.

In the situation illustrated in FIG. 7 which was achieved by tipping the backrest forwards the seat frame can now be pushed forwards with the backrest tipped forwards in the seat longitudinal direction L in order to make it easier for a passenger to enter or place articles in the back of the motor vehicle.

If the seat is then moved back again with the backrest folded forwards it is automatically stopped at the latest in the memory position defined by the locking pawl 104. For on reaching the memory position the stop 132 of the seat frame engages with the stop 144 of the memory device so that further movement of the seat frame downwards is prevented.

If then the backrest is folded back again into its function position the tension of the cable 121b is released and the switch lever 106 as well as the operating lever 109 with the projection 191 fixed thereon move back into the position illustrated in FIGS. 6 and 6a. If then the operating lever 109 is pivoted anti-clockwise to release the fixing device 120 then the position shown in FIG. 8 is reached.

On manually pivoting the operating lever 109 by means of the operating handle provided for this purpose the fixing device 120 is indeed released through the operating element 120b so that the seat frame can be moved in the seat longitudinal direction L on the rail 101 fixed on the body; but—as opposed to folding the backrest forwards—here the switch lever 106 remains in its upright position in which its operating section 160 acts vertically on the operating surface 140. This prevents the locking pawl 104 from becoming locked under the action of the compression spring 400.

As a result of the lever projection 191 which is swivelled down according to FIG. 8 and which correspondingly does not bear against the associated stop 163 of the switch lever 106 the vertical position of the switch lever 106 has to be secured for example through a suitable design of the operating surface 140 of the locking pawl 104. The operating surface 140 can for this purpose be curved so that under the action of the compression spring 400 of the locking pawl 104 it cannot exert on the operating section 160 of the switch lever 106 any torque which would cause the switch lever 106 to swivel anti clockwise. In other words, the interactive play between the operating surface 140 of the locking pawl 104 and the operating section 160 of the switch lever 106 has to be designed so that through the forces introduced by the compression spring 400 from the locking pawl 104 no anti-clockwise swivel movement of the switch lever 106 is triggered. Swivel movement of the switch lever 106 in a clockwise direction is however blocked through the cable nipple 168.

Alternatively the vertical position of the switch lever 106 can as already mentioned above also be secured by means of a suitable spring element or by sufficiently large friction forces.

In short the operation of the operating lever 109 in the memory position of the seat (with the backrest not tipped forwards) leads on the one hand to the fixing device 120 becoming released whilst at the same time the locking pawl 104 and thus the memory device overall remains in the released position which already existed prior to swivelling of the operating lever 109, see FIGS. 6 and 6a. Furthermore the follower 143 of the memory device engages in the engagement area 134 of the stop element 103 on the seat rail side.

In this state movement of the seat frame in the seat longitudinal direction L leads to the locking pawl 140 being entrained at the same time so that a new memory position is also set at the same time as the seat is displaced. The newly set memory position which corresponds to the seat longitudinal position newly set by sliding the seat frame is however not immediately locked if the operating lever 109 is let go. For this has at first according to FIGS. 6 and 6a the result that the fixing device 120 is locked and thus the seat rail 102 is stopped relative to the rail 101 fixed on the body. Locking of the memory device takes place however according to FIG. 7 only when the seat back is tipped forwards in the new seat longitudinal position. With the present embodiment the memory device is then only locked when the seat is moved forwards with the backrest tipped forwards within the scope of the easy-entry function.

FIG. 9 shows the seat frame according to which with the backrest tipped forwards it was first pushed forwards in the seat longitudinal direction L whereby the locking pawl 104 has been let back locked in the original seat position, and after which then the backrest was tipped back into its function position. Furthermore the operating lever 109 is swivelled so that the fixing device 120 is released and the seat frame can be moved selectively forwards or back in the seat longitudinal direction. In each seat longitudinal position which is hereby reached the seat frame can be locked by the fixing device 120 relative to the body-side rail 1 by letting go of the operating lever 109.

FIG. 10 shows finally the position of the seat frame when the latter has been moved back into the memory position with the backrest upright. The switch lever 106 hereby stops with its operating section 160 against a projection 140a which protrudes vertically up from the operating face 140 of the locking pawl 104. This is due to the fact that the locking pawl 104 is located in the locked position in which it engages by its detent hook 141 (see FIG. 6a) in a catch opening 170 of the ratchet rail 107. Through the inclined position of the operating surface 140 of the locking pawl 104 connected with this the latter exerts on the operating section 160 of the switch lever 106 a torque with a component parallel to the seat longitudinal direction L. As a result of this the switch lever 106 is pivoted anti-clockwise and its operating section 160 stops with the projection 140a of the locking pawl 104. This has the result that the locking pawl 104 remains further locked when the seat underframe reaches the memory position shown in FIG. 10.

In short therefore the operating surface 140 in the locked state of the locking pawl 104 interacts with the operating section 160 of the switch lever 106 so that the latter is pivoted when the seat is pushed with the backrest upright into the memory position whereby release of the locking pawl 104 is prevented. (If the seat is pushed backwards into the memory position whilst the backrest is tipped forwards, then the switch lever 106 as a result of the action of the cable nipple 168 is in any case pivoted, see FIG. 7, so that also in this case no release of the memory device can take place). On the other hand the operating surface 140 of the locking pawl 104 and the operating section 160 of the switch lever 106 interact in the released state of the locking pawl 104, see FIG. 6 so that the locking pawl 104 remains unlocked, as explained in further detail above with reference to FIG. 6).

As a result of the locked state of the locking pawl 104 the seat frame is automatically stopped on reaching the memory position when the stop 132 of the stop element 103 on the seat frame side becomes blocked with the counter stop 144 of the memory device see FIG. 6a).

If then in the memory position the operating lever 109 is let go then it swivels clockwise under the action of the spring assembly 120a of the fixing device 120 until the fixing device 120 is locked again. At the same time as a result of the projection 191 of the operating lever 109 which acts on the angled stop 163 in the upper section 161 of the switch lever 106 the switch lever 106 is swivelled clockwise into its perpendicular position whereby the switch lever 106 acts by its operating section 160 on the operating surface 140 of the locking pawl 104 and releases same (against the action of the compression spring 400), which requires a corresponding design of the spring assembly 120a. The seat is then located again in the position explained with reference to FIGS. 6 and 6a in the memory position with the backrest raised up.

Different embodiments will now be explained with reference to FIGS. 1a to 5c showing how according to the present invention swivel movement of the backrest onto the seat surface of the seat frame is transferred to the coupling mechanism which thereupon releases the fixing device of the longitudinal guide.

The following details on FIGS. 1a to 5b are substantially restricted to the interaction of the coupling mechanism with the backrest of the seat frame. Further details are not given on the remaining structural groups of the seat assembly such as e.g. the rail longitudinal guide, the fixing device of the rail longitudinal guide, the memory device and the interaction of these structural groups. For this reference is made to the details provided above relating to FIGS. 6 to 10.

In FIGS. 1a, 1b and 2a seat frame G is shown which comprises the following: a seat longitudinal guide 101, 102; a fixing device 120 for locking the longitudinal guide in a previously selected seat longitudinal position; a programmable memory device associated with the longitudinal guide 101, 102 and not shown in the figures, with which a previously programmed seat longitudinal position can be found again; a pair of seat side parts 108 which can be vertically adjusted by suitable lever H; as well as a backrest R which is attached to the side parts 108 to pivot about an axle 180.

The backrest R can in turn be pivoted between different useful positions in which it serves each time to support the back of a person located on the seat, whereby the relevant incline of the backrest R can be adapted to the needs of the seat user. Adjusting the incline is carried out by means of a hand wheel 180a mounted on the pivotal axis 180.

Furthermore this backrest can also (as shown in FIG. 1a by an arrow P) be tipped onto the seat surface of the corresponding seat frame G (not shown in FIG. 1a). Hereby at the same time as already described previously with reference to FIGS. 6 to 11 the fixing device 120 of the longitudinal guide 101, 102 becomes released so that the seat can be easily displaced with the backrest tipped forwards. For this a coupling mechanism is required which as the backrest is tipped forwards beyond a certain angle (e.g. with a forward incline of the backrest R of more than 60 degrees relative to the perpendicular) causes release of the fixing device. An example of a coupling mechanism of this kind was already described with reference to FIGS. 6 to 10. Presently this relates to the coupling (not shown in FIGS. 6 to 10) between this coupling mechanism and the backrest R.

According to FIGS. 1a, 1b and 2a section 182 of the outer contour of a component part which can pivot together with the backrest R, namely a backrest fitment 181, serves as the stop to which a counter stop 186 is assigned provided on a coupling element 185 which is mounted rotatable on the pivotal axis 180. These two stops 182, 186 interact so that when the backrest R is tipped forwards in the direction P onto the seat surface the stop 182 on the backrest fitment side (operating stop) by acting on the associated counter stop 186 causes pivotal movement of the coupling element 185. A cable mounting 188 is in turn provided on this coupling element 185 for a cable which is guided in a Bowden cable 121a and which becomes taut as the coupling element 185 is pivoted. This leads to release of the fixing device 120, as already explained above with reference to FIGS. 6 to 10. For this purpose a gearing part 122 is provided on the end of the Bowden cable 121a remote from the backrest R and as the cable guided in the Bowden cable 121a becomes taut is pivoted so that it acts through the operating lever 109 on the operating element 120b of the fixing device 120 so as to release same. The release takes place at the moment at which a defined tautening of the cable is reached corresponding to a defined pivotal movement of the backrest R, and thus also the coupling element 185, forwards.

FIG. 1b further shows a backrest-side support 189 of the Bowden cable 121a.

FIG. 3a again shows on an enlarged scale how the stop 182 on the backrest side interacts with the stop 186 provided on the coupling element 185 so that the coupling element 185 during tipping forward of the backrest towards the seat surface is swivelled forwards whereby a cable mounting 188 provided on the coupling element 185 is moved so that a cable guided in a Bowden cable 121a and hanging from the mounting becomes taut whereby—as shown previously with reference to FIGS. 6 to 10—a release of the fixing device 120 of the seat longitudinal guide can take place. Furthermore action is also possible through the Bowden cable 121a—as apparent from FIGS. 6 to 10—on a memory device of the longitudinal guide.

FIG. 3b shows the two stops 182, 186 in a position in which they are spaced from each other. This corresponds to a backrest inclined backwards.

FIGS. 4a and 4b show a modification of the embodiment of FIGS. 1a to 3b. A difference exists here in that according to FIGS. 4a and 4b the operating fitment 183 on the backrest side is formed not by a section of the outer contour of the backrest fitment 181 but by a projection protruding from the backrest fitment.

Furthermore the coupling element 187 mounted rotatable on the pivotal axis 180 of the backrest is here formed as a lever which forms a constituent part of a lever assembly or lever mechanism which extends from the swivel axis 180 up to a gearing element 199 which can act though an operating lever 109 on the operating element 120b of the fixing device 120 in order to release same. This lever assembly which forms the coupling mechanism between the backrest and the fixing device 120 of the seat longitudinal guide 101, 102 comprises in addition to the coupling element 187 a rigid lever 195 which runs on a curved path and is connected for articulation to the coupling element 187, a further lever 198 which extends in the seat longitudinal direction L and is connected for articulation to the rigid lever, as well as the gearing element 199 which is connected for articulation to the last-mentioned lever 198 and which can act on the operating lever 109 in order to release the fixing device 120.

In the state shown in FIGS. 4a and 4b the stop 183 which is provided on the backrest fitment 181 is spaced by a defined path s from the coupling element 187. When tipping the seat back forwards in the direction P this projection 183 pivots in the direction of the coupling element 187 and engages with this from a certain forward incline of the backrest so that the coupling element 187 is pivoted together with the backrest about its pivotal axis 180. This pivotal movement of the coupling element 187 is transferred through the further lever 195, 198 of the coupling mechanism to the gearing part 199 which then moves the operating lever 109 and thus the operating element 120b of the fixing device 120 down whereby this is released.

This lever assembly can act through a further lever 197 on the switch lever 106 of the memory device in order to control the locking and release of the memory device of which in FIG. 4b the locking pawl 104 is visible, as explained above with reference to FIGS. 6 to 10. As a result of the plurality of articulated joints 195a, 195b, 199a through which the levers 187, 195, 198 and 199 are connected, more particularly the joint 195b assigned to the further lever 197, with this lever assembly it is also possible to compensate for changes in the height of the pivotal axis 180 of the backrest which occur as a result of adjusting the seat height through a suitable adjusting lever H so that the further lever 197 acts in a defined way through the switch lever 106 on the memory device independently of the setting of the seat height.

By selecting the distance s between the projection 183 on the backrest fitment 181 serving as the operating stop, and the coupling element 187 in an upright (vertical) position of the backrest it is established how far (about which angle) the backrest has to be folded forwards until the operating stop 183 acts on the coupling element 187 and thus triggers operation of the fixing device 120 through the coupling mechanism provided for this purpose.

FIGS. 5a to 5b show a further modification of the embodiment shown in FIGS. 1a to 3b whereby here—as also in FIGS. 4a and 4b—a lever assembly serves for transferring the pivotal movement of the backrest as it is tipped forwards onto the seat surface to the operating element 120b of the fixing device 120.

According to FIGS. 5a and 5b the coupling element 187 which is formed as a lever is hereby provided with a longitudinal guide 187a in which one end 196a of a straight lever 196 is mounted for articulation and longitudinal displacement. This lever 196 replaces the curved lever 195 of FIGS. 4a and 4b and is likewise connected at its end remote from the backrest through an articulated joint 196b for articulation with a lever 198 which extends substantially in the seat longitudinal direction L. By means of the longitudinal guide 187a changes in the height of the swivel axis 180 of the backrest relative to the longitudinal guide 101, 102 can be compensated whereby with a defined incline of the backrest R the distance s between the stop 183 provided on the backrest fitment 181, and the coupling element 187 remains constant independently of the adjustment of the height of the backrest axis 180.

Furthermore as far as the coupling mechanism is concerned this embodiment agrees with that explained with reference to FIGS. 4a and 4b so that reference is made to the above embodiments regarding further details.

With the embodiments described with reference to FIGS. 1a to 5b the release of the fixing device 120 takes place preferably each time against the action of elastic elements which can be provided on the fixing device 120 itself, on the operating lever 109 or on suitable elements of the relevant coupling mechanism which couples the backrest to the operating lever 109. The relevant stop 182, 183 on the backrest side acts each time against the force of the corresponding elastic elements on the relevant coupling element 185, 187 which has the tendency then to return to its original position when the corresponding stop 182, 183 no longer acts on the coupling element after the backrest has been raised up again back from the seat surface.

1. Motor vehicle seat with
a seat frame (G)
a backrest (R) which is mounted pivotally on the seat frame (G) and can be tipped forwards towards a seat surface of the seat frame (G)
a longitudinal guide (101, 102) with which the seat frame (G) can be moved in the seat longitudinal direction (L) to adjust the seat longitudinal position,
a fixing device (120) for locking the seat frame in a previously set seat longitudinal position,
an operating element (120b) for releasing the fixing device (120) so that the seat frame (G) can be moved in the seat longitudinal direction (L)
a coupling mechanism which acts on the operating element (120b) and releases the fixing device (120) when the backrest (R) has been tipped forwards onto the seat surface
characterised in that
an operating stop (182, 183) is provided on a component part (181) which can pivot with the backrest (R) and when the backrest (R) is tipped forwards towards the seat surface this operating stop acts on a rotatably mounted coupling element (185, 187) which forms a constituent part of the coupling mechanism.

2. Motor vehicle seat according to claim 1 characterised in that the coupling element (185, 187) is mounted on the pivotal axis (180) of the backrest (R).

3. Motor vehicle seat according to claim 1 or 2 characteris d in that the operating stop (182, 183) acts from a predeterminable forward incline of the backrest on the rotatably mounted coupling element (185, 187).

4. Motor vehicle seat according to one of the preceding claims characterised in that the component part (181) which can swivel together with the backrest (R) is formed by a backrest fitment.

5. Motor vehicle seat according to one of the preceding claims characterised in that the operating stop (182) is formed by a section of the outer contour of the component part (181) which can swivel together with the backrest (R).

6. Motor vehicle seat according to one of claims 1 to 4 characterised in that the operating stop (183) projects from the component part (181) which can pivot together with the backrest (R).

7. Motor vehicle seat according to one of the preceding claims characterised in that the coupling mechanism comprises a lever assembly (195, 196, 198, 199) which extends from the component part (187) which can pivot together with the backrest (R) up to the fixing device (120).

8. Motor vehicle seat according to claim 7 characterised in that the lever assembly comprises at least one articulated joint (195a, 195b; 196a, 196b) in order to compensate any change in the height of the pivotal axle (180) of the backrest (R) relative to the longitudinal guide (101, 102).

9. Motor vehicle seat according to claim 7 or 8 characterised in that the lever mechanism has at least one longitudinal guide (187a) in order to compensate any change in the height of the pivotal axis (180) of the backrest (R) relative to the longitudinal guide (101, 102).

10. Motor vehicle seat according to one of claims 7 to 9 charact ris d in that the coupling element (187) forms a constituent part of the lever assembly.

11. Motor vehicle seat according to one of claims 1 to 6 characterised in that the coupling mechanism comprises a Bowden cable (121a) which extends from the component part (185) which can pivot together with the backrest (R) up to the fixing device (120).

12. Motor vehicle seat according to claim 11 characterised in that the core of the Bowden cable (121a) is connected to the component part (185) which can pivot together with the backrest (R).

13. Motor vehicle seat according to one of the preceding claims characterised by a memory device (104, 105, 107) by means of which the seat frame (G) during movement in the seat longitudinal direction can be stopped automatically in a predeterminable seat longitudinal position defined as the memory position.

14. Motor vehicle seat according to claim 13 characterised by adjusting means (105) of the memory device (104, 105, 107) with which the memory position can be adjusted in the seat longitudinal direction (L); a locking device (104, 107) of the memory device (104, 105, 107) for locking a set memory position; as well as switch means (106) with which the locking device (104, 107) can be released in order to be able to adjust the memory position.
